(19) United States
(12) Patent Application Publication
(10) Pub. No.: US 2010/0236912 A1
(43) Pub. Date: Sep. 23, 2010

(54) SNAP ACTION SWITCH WITH A NON-METAL INTERCHANGEABLE SPRING

(75) Inventor: Manuel Anaya, Ciudad Juarez (MX)

Correspondence Address: HONEYWELL/IFL;Patent Services, 101 Columbia Road, P.O.Box 2245, Morristown, NJ, 07962-2245, US

(73) Assignee: Honeywell International Inc.

(21) Appl. No.: 12/408,332

(22) Filed: Mar. 20, 2009

(51) Int. Cl. H01H 5/00; B23P 11/00

(52) U.S. Cl. 200/468; 29/428

(57) ABSTRACT

A snap action switch apparatus and method includes a non-metal interchangeable spring for providing a customized spring force thereof. The apparatus further includes one or more mutually spaced fixed contact elements and one or more movable contact elements that can move between a closed position and an open position. An actuating member can be provided for moving the contact elements between the closed position and the open position. The non-metal interchangeable spring can be utilized for performing a snap action operation and is capable of supplying a force needed to maintain the movable contacts in one or more positions. A switch mechanism (e.g., push button) eliminates the applied force to change the movable contacts to the normally open position.

### TECHNICAL FIELD

Embodiments are generally related to electrical switching devices and methods. Embodiments are also related to snap action electrical switches Embodiments are additionally related to snap action springs.

### BACKGROUND OF THE INVENTION

Electrical switches typically operate to open and close an electrical circuit by moving one or more contacts between contact positions. Most “snap action” switches, for example, employ a snap disc disposed in a housing such that the snap disc is sensitive to an applied force. The snap disc generally possesses a convex surface that changes shape to an inverted configuration due to a snap action when the applied force attains a preset threshold. Snap disc switches also may include a movable connecting member and a movable contact arm engaged with the snap disc such that when the snap disc changes configurations between first and second shapes, the movable contact is moved between the open and closed contact positions.

The majority of prior art electrical snap action switches utilize an electrical contact that is located between a metal snap action plate and metal pins (or conductors on a printed circuit board). The presence of several metal-based components and the extended travel of such components can increase the susceptibility of component failure. Additionally, such snap action switches are not easily adjustable when selecting the threshold set point and the operating characteristics of the snap action switch cannot be changed easily. Furthermore, the cost for packaging such metal-based components increases, which further enlarges the size of the final snap action switch assembly and the complexity of the resulting system, may cause a reduction in reliability.

Based on the foregoing, it is believed that a need exists for an improved snap action switch apparatus having a non-metal interchangeable spring for providing a customized spring force. It is also believed that a need exists for an improved snap action spring that offers a high reliability, is easy to assemble, and is inexpensive, as described in greater detail herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved snap action switch apparatus.

It is another aspect of the present invention to provide for an improved snap action switch apparatus having a non-metal interchangeable spring for providing customized spring force.

It is a further aspect of the present invention for an improved snap action spring.

The aforementioned aspects and other objectives and advantages can now be achieved as described herein. A snap action switch apparatus is disclosed, which includes a non-metal interchangeable spring for providing customized spring force. The apparatus further includes one or more mutually spaced fixed contact elements and one or more movable contact elements that can move between a normally closed position and a normally open position. An actuating member can be provided for moving the contact elements between the closed position and the open position. The non-metal interchangeable spring can be utilized for performing a snap action operation and is capable of supplying a force needed to maintain the movable contacts in at least one position. A switch mechanism (e.g., a push button) eliminates the applied force to change the movable contacts to the normally open position. The non-metal interchangeable spring can be utilized to achieve a customized spring force in order to easily change and modify the operating characteristics of the snap action switch apparatus.

The non-metal interchangeable spring comprises a dome spring (e.g., rubber) and/or arc shaped spring (e.g., plastic). The dome spring acts as a compressed spring and applies the force to the switch apparatus. The arc-based spring can be anchored to a base (e.g., plastic) at one end and can be attached to the movable contact at the other end. The molded shape of the arc-based spring can be utilized as a normal state. The non-metal interchangeable spring (domed spring and/or arc based spring) can reduce the amount of metal components thereby reducing the cost associated with the production of the snap action switch apparatus. Accordingly, the snap action switch apparatus of the present invention employs the non-metal interchangeable spring that offers high reliability and requires minimal metal components thereby providing a compact and simple structure.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a front view of a snap action switch apparatus associated with a dome spring, in accordance with a preferred embodiment;

FIG. 2 illustrates a side view of the snap action switch apparatus associated with the dome spring, in accordance with a preferred embodiment;

FIG. 3 illustrates a perspective side view of the snap action switch apparatus associated with the dome spring, in accordance with a preferred embodiment;

FIG. 4 illustrates a front view of a snap action switch apparatus associated with an arc shaped spring, in accordance with a preferred embodiment;

FIG. 5 illustrates a side view of the snap action switch apparatus associated with the arc shaped spring, in accordance with a preferred embodiment; and

FIG. 6 illustrates a perspective side view of the snap action switch apparatus associated with the arc shaped spring, in accordance with a preferred embodiment.

### DETAILED DESCRIPTION

The particular values and configurations discussed in these non-limiting examples can be varied and are cited merely to illustrate at least one embodiment and are not intended to limit the scope thereof.

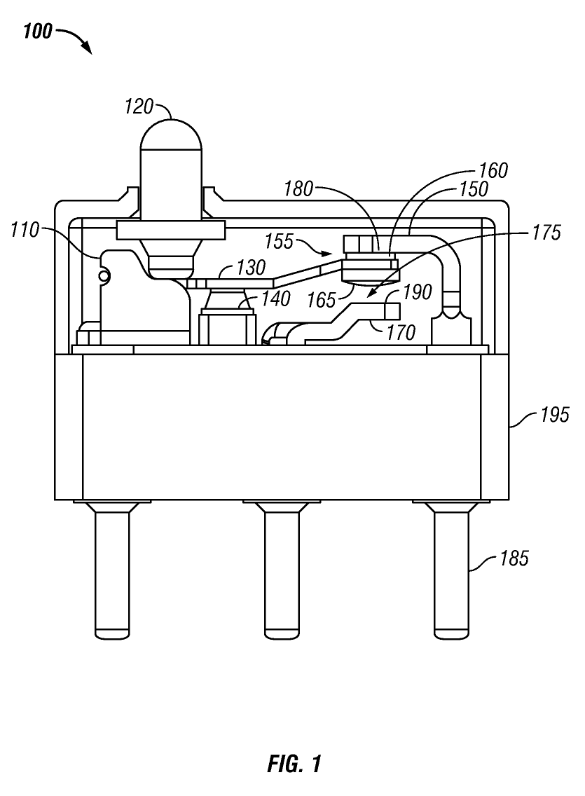

FIG. 1 illustrates a front view of a snap action switch apparatus 100 associated with a dome spring 140, in accordance with a preferred embodiment. The snap action switch apparatus 100 generally includes, for example, one or more mutually spaced fixed contact elements 180 and 190, an actuating member 130 and a dome shaped spring 140. The dome spring 140 functions as a suitable contactor element for closing and opening a circuit between contacts associated with the snap action switch apparatus 100. The fixed contact elements 180 and 190 can be mounted to the fixed contact plate members 150 and 170, respectively. The actuating member 130 can be fixed to a base 110 at one end and one or more movable contact elements 160 and 165 at the other end. The movable contact elements 160 and 165 can move between a normally closed position 155 and a normally open position 175. The snap action switch apparatus 100 can be assembled within a housing 195 that includes electrical leads 185, which can be utilized to connect the switch apparatus 100 with an external electrical connection.

The movable contact element 165 can move to the closed position 155 for connecting the fixed contact element 180 in an electrically conductive manner. The dome spring 140 is capable of supplying a force to maintain the snap action switch apparatus 100 in normally closed position 155 or in the normally open position 175. The dome shaped spring 140 described herein may be configured from a material such as, for example, rubber, depending upon design considerations. It can be appreciated that other types of materials may be utilized in place of the suggested material. A switch mechanism 120 (e.g., a push button) can be utilized to eliminate the acting force and make the snap action switch apparatus 100 to retain the normally open position 175.

The dome spring 140 possesses a generally circular periphery and is received within a recess, having a corresponding circular periphery so as to maintain a normally upwardly convex configuration. It can be appreciated, of course, that other shapes may be utilized to implement the dome spring 140. The characteristics of the dome spring 140 are a function of various design parameters such as, for example, diameter, thickness, radius of curvature, and stiffness of material that can be selected depending upon design considerations. When the dome spring 140 is pressed, it flexes in a snap action movement so that a portion of the dome spring 140, typically the central portion, presses against the actuating member 130 and thereby establishes an electrical connection between the fixed contacts 180 and 190 and the movable contacts 160 and 165. When pressure is removed, the dome spring 140 snaps back to a stable position and thereby break contact with the fixed contacts 180 and 190.

The dome spring 140 can be supported by a thin web, which provides the necessary elasticity to permit the dome spring 140 to be depressed and actuate the snap action switch apparatus 100. When the applied pressure by the switch mechanism 120 is removed, the thin web can facilitate the dome spring 140 to spring back to its original position. The switch mechanism 120 and the dome spring 140 can spring back out of engagement as a result of the elasticity associated with the dome spring 140 when the actuating force is removed.

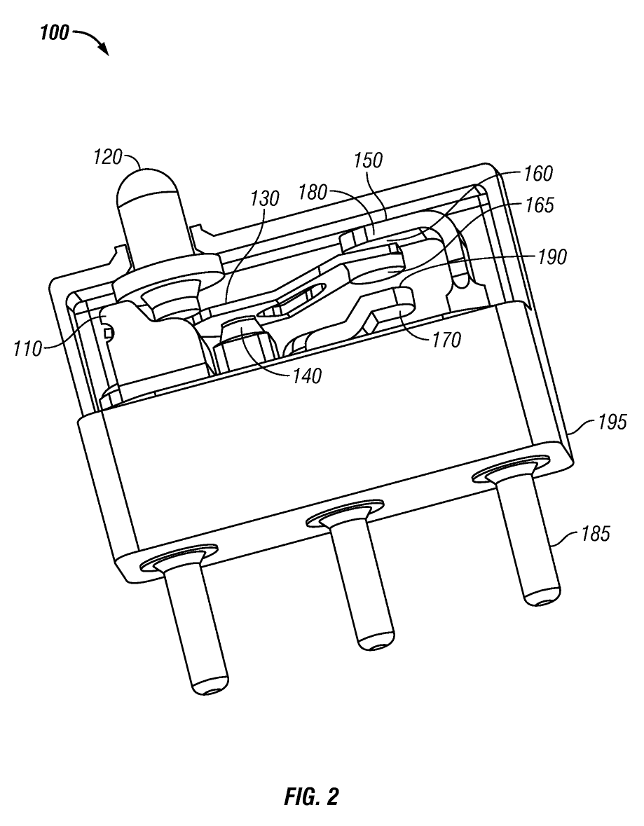

FIG. 2 illustrates a side view of the snap action switch apparatus 100 associated with the dome spring 140, in accordance with a preferred embodiment. Note that in FIGS. 1-6, identical or similar blocks are generally indicated by identical reference numerals. The dome spring 140 affords improved force versus displacement and snap action characteristics. The actuating member 130 interconnects the switch mechanism 120 and the dome spring 140 and is responsive to and converts a vertical downward movement of the switch mechanism 120 to a horizontally directed depressing force on the dome spring 140 for inverting the dome spring 140 in a snap action from one fixed contact 180 to the other 190 and vice-versa.

The dome spring 140 and the actuating member 130 can return to their original positions upon removal of the external force. The actuating member 130 located within the internal cavity of the switch apparatus 100 can be extended around the fixed terminals 180 and 190 in sufficiently spaced apart relationship with respect thereto so that the snap action switch 100 can have sufficient gap and creep age distance between and among the actuating member 130 and the fixed contacts 180 and 190, and other parts electrically connected thereto. The snap action switch apparatus 100 can provide excellent characteristics with respect to electrical insulation.

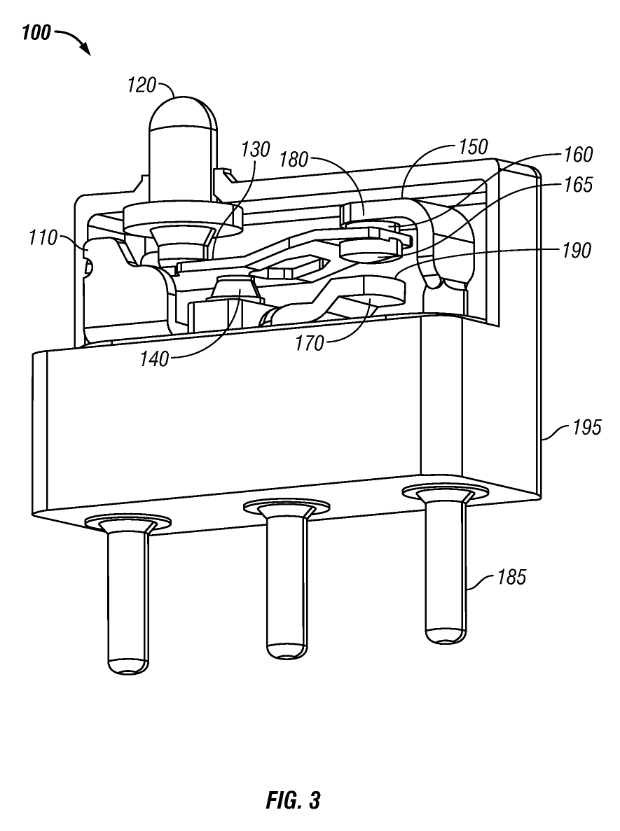

FIG. 3 illustrates a perspective side view of the snap action switch apparatus 100 associated with the dome shaped spring 140, which can be implemented in accordance with a preferred embodiment. The dome spring 140 acts as a compressed spring and applies the force to the switch apparatus 100. The actuating member 130 is elongated and the stroke of the dome spring 140 required for completing the snap action movement of the switch apparatus 100 can be reduced and the operating force required to effect the switching actuation of the switch apparatus 100 can also be reduced. The snap action switch apparatus 100 requires a very low operating force to effect the switching actuation.

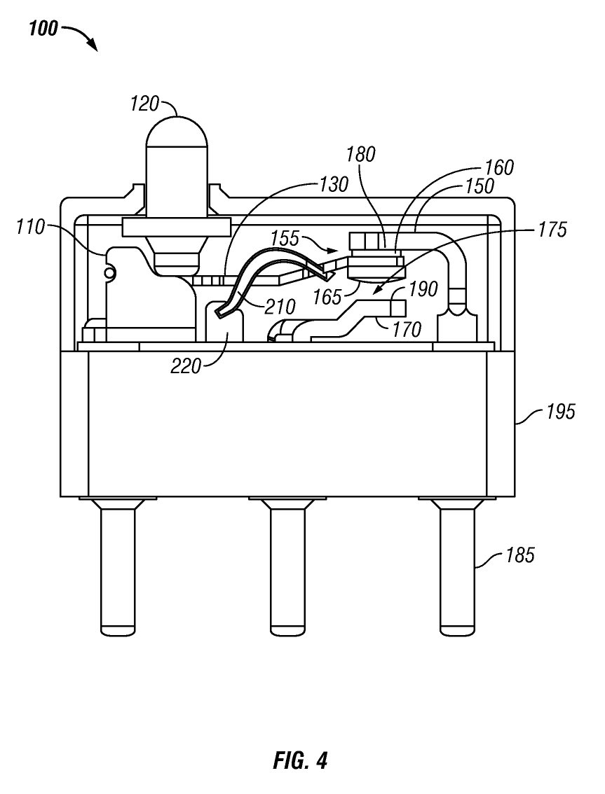

FIG. 4 illustrates a front view of a snap action switch apparatus 200 associated with an arc shaped spring 210, in accordance with a preferred embodiment. Again as reminder, in FIGS. 1-6, identical or similar blocks are generally indicated by identical reference numerals. The contact making and breaking for a single electric current path involves two fixed contacts 180 and 190 cooperating with the actuating member 130. The movable contacts 160 and 165 are disposed opposite the fixed contacts 180 and 190, respectively, with a predetermined gap therebetween. The snap action switch apparatus 200 includes the arc shaped spring 210, which is anchored in the support means 220 (e.g., plastic) at one end and can be attached to the actuating member 130 at the other end.

The arc shaped spring 210 provides snap action movement in response to changes in force exerted upon the arc shaped spring 210. The molded shape of the arc shaped spring 210 can be utilized as a normal state. The arc shaped spring 210 described herein may be configured from a flat, resilient material such as, for example, plastic, depending upon design considerations. It can be appreciated that other types of materials may be utilized in place of the suggested material. The switch mechanism 120 can be located above the arc shaped spring 210 and can be depressed in a snap action manner.

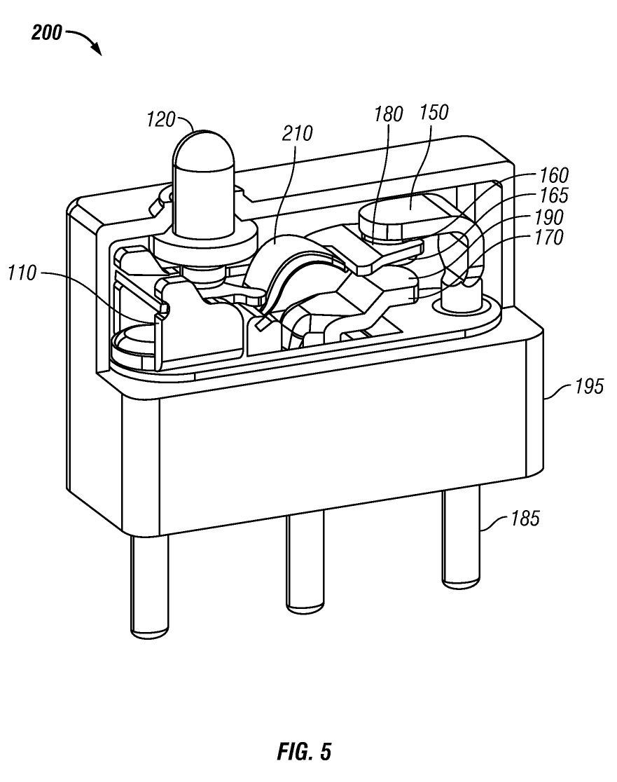

FIG. 5 illustrates a side view of the snap action switch apparatus 200 associated with the movable contacts 160 and 165 and the arc shaped spring 210, in accordance with a preferred embodiment. The actuating member 130 possesses a first movable contact 160 and a second movable contact 165. The first movable contact 160 can be configured for contacting an open type fixed contact 190 and the second movable contact 165 can be configured for contacting a closed type fixed contact 180. The movable contact 160 can rest in contact with the open type fixed contact 190 in the open position 175. Accordingly, the arc shaped spring 210 changes shape by way of a snapping action to either open circuit or close circuit the electrical connection between the fixed contacts 180 and 190. The switch apparatus 200 can therefore control the current flow between the fixed contacts 180 and 190, which can control energizing of an electrically powered device.

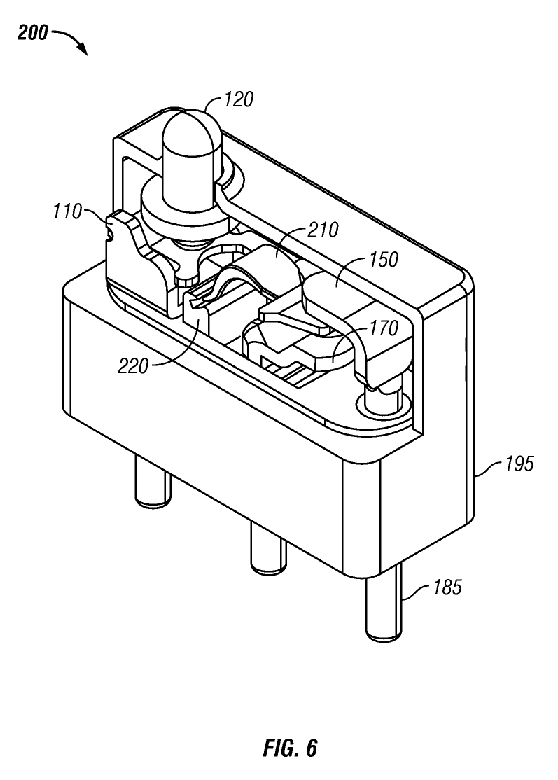

FIG. 6 illustrates a perspective side view of the snap action switch apparatus 200 associated with the movable contacts 160 and 165 and the arc shaped spring 210, which can be implemented in accordance with a preferred embodiment. The actuating member 130 is connected to the arc shaped spring 210 positioned and designed to build up and then release applied force beyond a given amount in order to generate the snap action involved in the snap action switch apparatus 200. The arc shaped spring 210 can function as an elongated central compression member having a curved or bowed configuration. The switch mechanism 120 acts on the spring 210, eventually moves the compression member through the center of its bowed shape to open or close the electrical contacts 180 and 190. The switch mechanism 120 contacting the actuating member 130 is pressed which results in the corresponding movement of the actuating member 130.

The arc shaped spring 210 is configured to be compressed to a certain point based upon the orientation of the spring 210 in the switch apparatus 200 and then the compression is released as the spring 210 is moved through an arc of motion. Also, the spring 210 generates a constant upward pressure on the actuating member 130, which can allow the spring 210 to return to its original (default) position following activation.

Note that detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

The non-metal interchangeable spring (e.g., dome spring 140 and the arc based spring 210) can be utilized to achieve a customized spring force in order to change and modify the operating characteristics of the snap action switch apparatus 100 and 200. The non-metal interchangeable spring can reduce the amount of metal components thereby reducing the cost associated with the production of the snap action switch apparatus. Accordingly, the snap action switch apparatus 100 and 200 of the present invention employs the non-metal interchangeable spring that offers high reliability and requires minimal metal components thereby providing a compact and simple structure.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A snap action switch apparatus, said apparatus comprising:
a plurality of mutually spaced fixed contacts and a plurality of movable contacts, wherein said plurality of movable contacts is capable of moving between a normally closed position and a normally open position with respect to said snap action switch apparatus;
a switch mechanism in association with a non-metal spring for performing a snap action operation, said non-metal spring capable of supplying a force required to maintain said plurality of movable contacts in at least one position, wherein said switch mechanism eliminates said force to change said plurality of movable contacts to said normally open position; and
an actuating member interconnecting said switch mechanism and said non-metal spring for moving said plurality of movable contacts between said normally closed position and said normally open position, wherein said non-metal spring provides a customized spring force in order to thereby alter said non-metal spring and modify an operating characteristic of said snap action switch apparatus.

2. The apparatus of claim 1 wherein said non-metal spring is interchangeable.

3. The apparatus of claim 1 wherein said non-metal spring comprises a dome spring.

4. The apparatus of claim 1 wherein said non-metal spring comprises an arc shaped spring.

5. The apparatus of claim 3 wherein said dome spring comprises a rubber material.

6. The apparatus of claim 3 wherein said dome spring comprises a compressed spring in order to apply said force to said apparatus.

7. The apparatus of claim 4 wherein said arc shaped spring comprises a plastic material.

8. The apparatus of claim 4 wherein said arc shaped spring is anchored in a base at one end and attached to said movable contacts at another end thereof.

9. The apparatus of claim 1 wherein said switch mechanism comprises a push button.

10. A snap action switch apparatus, said apparatus comprising:
a plurality of mutually spaced fixed contacts and a plurality of movable contacts, wherein said plurality of movable contacts moves between a normally closed position and a normally open position with respect to said snap action switch apparatus;
a switch mechanism in association with a non-metal spring for performing a snap action operation, wherein said non-metal spring is interchangeable and capable of supplying a force required to maintain said plurality of movable contacts in at least one position, and said switch mechanism eliminates said force to change said plurality of movable contacts to said normally open position; and
an actuating member interconnecting said switch mechanism and said non-metal spring for moving said plurality of movable contacts between said normally closed position and said normally open position wherein said non-metal spring provides a customized spring force in order to thereby alter said non-metal spring and modify an operating characteristic of said snap action switch apparatus.

11. The apparatus of claim 10 wherein said non-metal spring comprises a dome spring.

12. The apparatus of claim 10 wherein said non-metal spring comprises an arc shaped spring.

13. A method of configuring a snap action switch apparatus, said method comprising:
associating a plurality of mutually spaced fixed contacts with a plurality of movable contacts, wherein said plurality of movable contacts moves between a normally closed position and a normally open position with respect to said snap action switch apparatus;
providing an switch mechanism and a non-metal spring for performing a snap action operation, said non-metal spring capable of supplying a force required to maintain said plurality of movable contacts in at least one position, wherein said switch mechanism eliminates said force to change said plurality of movable contacts to said normally open position; and
interconnecting an actuating member with said switch mechanism and said non-metal spring for moving said plurality of movable contacts between said normally closed position and said normally open position, wherein said non-metal spring provides a customized spring force in order to thereby alter said non-metal spring and modify an operating characteristic of said snap action switch apparatus.

14. The method of claim 13 further comprising configuring said non-metal spring as an interchangeable component.

15. The method of claim 13 further comprising configuring said non-metal spring as a dome spring.

16. The method of claim 13 further comprising configuring said non-metal spring as an arc shaped spring.

17. The method of claim 15 wherein further comprising configuring said dome spring as a compressed spring in order to apply said force to said snap action switch apparatus.

18. The method of claim 15 further comprising configuring said arc shaped spring from a plastic material.

19. The method of claim 15 further comprising anchoring said arc shaped spring in a base at one end and attached to said movable contacts at another end thereof.

20. The method of claim 15 further comprising configuring said switch mechanism as a push button.
